(19) United States
(12) Patent Application Publication
(10) Pub. No.: US 2016/0100085 A1
(43) Pub. Date: Apr. 7, 2016

(54) Camera Having Optoelectronic Range Finder

(71) Applicant: Leica Camera AG, Wetzlar (DE)

(72) Inventor: Robert DENK, Braunfels (DE)

(21) Appl. No.: 14/966,835

(22) Filed: Dec. 11, 2015

Related U.S. Application Data
(63) Continuation-in-part of application No. PCT/DE2013/100215, filed on Jun. 13, 2013.

(51) Int. Cl. H04N 5/225; H04N 5/232; G02B 7/04

(52) U.S. Cl. CPC H04N 5/2254; G02B 7/04; H04N 5/2252; H04N 5/23293; H04N 5/23212

(57) ABSTRACT

A camera having an optoelectronic rangefinder, a focusable receiving lens and a visually observable display unit for displaying data and/or images, wherein the fact that two electronic image recording modules, which are spaced apart and the optical axes of which are aligned with a common target point, are inserted as a rangefinder into the front panel of the housing of the camera and, in order to determine the phase distance of the images of the object space recorded by the image recording modules and to compare the determined phase distance to the values for the distances assigned for the different phase distances, which are stored in a calibration table, a microprocessor unit is provided in the housing and is connected with the signal outputs of the image recording modules.

This application is a continuation-in-part of PCT International Application No. PCT/DE2013/100215, filed Jun. 13, 2013, the entire disclosure of which is expressly incorporated by reference herein.

The present invention relates to a camera having an optoelectronic rangefinder, a focusable receiving lens and a visually observable display unit for displaying data and/or images.

Digital cameras having these functional elements are known in various designs. The distance measurement is conventionally carried out through the receiving lens via an autofocus sensor which controls the distance setting of the receiving lens. The autofocus measurement either operates according to the contrasting method via the image sensor or according to the phase-comparison method with pupil division via a separate AF module. In the contrast method conventionally applied to viewfinder cameras, the receiving lens has to be turned over the focus range and iteratively be approached to the point of focus. This process is relatively slow. In contrast, the phase-comparison method predominately used for single-lens reflex cameras directly shows the direction of the focus offset and enables by zero correction of the phase a faster automatic focus setting and focus tracking, for example, for continuous shooting or panning shots.

The image section in focus for distance measurement is typically indicated by an image boundary within an image shown on a display on the back panel of the camera. Also known, however, are cameras having a viewfinder eyepiece in which the image section to be recorded and the autofocus measuring range are electronically displayed.

Manually focusable rangefinder cameras are usually provided with an optical rangefinder, which is mechanically coupled to a manually operable focusing ring of the receiving lens. For range-finding, two images are generated via separate viewfinder lenses, which are, by adjusting the receiving lens, moved to overlap in a viewfinder as superimposed or split images. The optical and mechanical design of such rangefinder systems is very costly, in particular, for cameras having interchangeable receiving lenses of different focal lengths for which different image field bounding boxes have to be reflected into the path of the viewfinder rays. In order to overlap the images in the viewfinder eyepiece, at least the optical axis of one of the viewfinder lenses has to be changed as a function of adjusting the focusing ring. The optical-mechanical adjustment of this system is difficult and dependents on the receiving lens and the rangefinder of the overall system. The advantage is the ability to design the image by individually selecting sharpness settings and the precision of measuring distance by triangulation which, however, is only suitable for manual focusing as it does not provide any electronically usable signals for an AF device.

The object of the present invention is to combine the advantages of an optomechanical rangefinder system with the advantages of an optoelectronic distance measuring system for AF control, and to additionally reduce production costs, mechanical design and adjustment effort.

This object is achieved according to the present invention in cameras having the features mentioned at the outset by the characterizing features of claim 1. Advantageous further refinements result from the features of the dependent claims.

The arrangement of two electronic image recording modules spaced apart enables to establish an appropriate base line for triangulation by selecting the distance. The alignment of the optical axes of the image recording modules towards a common target point prevents movable elements. Selecting the distance of the target point may influence the overlapping of the image angle areas detected by the two image recording modules, in particular, an adjustment to the image angles of exchangeable receiving lenses of various focal lengths or of zoom lenses may be achieved. Determining the phase difference of the images recorded by the image recording modules enables to indicate the measured distance relative to the distance of the target point. Test measurements having known object distances enable to create a calibration table for the relationship between measured phase distance and object distance and to store it for analysis by a microprocessor unit in the housing of the camera.

The rangefinder according to the present invention may be constructed as a stand-alone component and be mechanically pre-adjusted outside of the housing of the camera. A fine calibration of the image recording modules for phase correction may be carried out via software. The calibration table for measured supporting points of the distances may be interpolated for intermediate values of the distances via software calculation.

An integrated sensor displaying the current focus setting of the receiving lens may be assigned to the receiving lens. The sensor may, for example, also measure the deflection of a roller lever known per se, which abuts the control cam of the receiving lens. The measuring signal of the sensor may be input as an additional signal into the microprocessor unit.

The distance determined from the phase distance and measured by the sensor may be displayed on the visually observable display unit. It is advantageous for the evaluation by the user when the display unit visually indicates the object area in focus and the difference of the two distance values in comparison to the distance according to the phase correction in the form of directional symbols. In addition, specifications of the respective receiving lens, image field bounding box and/or exposure information may be displayed.

The receiving lens may be connected to a manual or motor-operable actuator for zeroing the difference of the distances indicated on the display unit. Thus, both, manually focusable receiving lenses as well as autofocus lenses, may be used on the camera.

In a manner known per se, an optical viewfinder having a viewfinder eyepiece and a viewfinder window for visually observing the object area in focus may be provided in the housing of the camera. In this instance, the display unit may be situated in the housing of the camera in such a manner that it may be observed via the viewfinder eyepiece.

Via the viewfinder eyepiece, a purely electronic viewfinder, however, may also be observed by an image-displaying display. A combination viewfinder, which shows either an optical or an electronic image via a splitter prism, may also be used in this situation. For this purpose, it is appropriate if the viewfinder window is dimmable. In order to cover the viewfinder window, a switchable optoelectronic component may be particularly provided, for example, a PNLC display, a glass prism having an electrically controllable liquid, an electrically controllable mirror, etc.

For electronic, thus, non-mechanical dimming of the viewfinder window, PNLC displays (polymer dispersed network liquid crystal) or also PDLC (polymer dispersed liquid crystal) have been proven to be advantageous. Particularly advantageous are specific display variations which have no reflecting or illuminated back panel in the transmitted-light mode, as it is otherwise common for displays. For special LC components which manage without additional polarizers, the solid particles of the liquid crystal are very finely distributively dissolved (dispersed) and, in this manner, the molecules already remain in an orderly position at very low voltage applied across the overall area and let the incident light pass through. Without applied voltage, the finely distributed liquid crystal molecules fall into a disorderly arrangement heavily scattering (and nearly blocking) the incident light. These components achieve, in particular for the visible light, very high transmission rates whereas, without applied control voltage, the light flux is almost interrupted. In contrast to conventional LC displays, gray scales are not possible for PNLC or PDLC components; there is only the ON state—molecules are in an orderly, light permeating state—or the OFF state—molecules are in a disorderly state scattering light towards impermeability. In this manner, the components may be used particularly efficiently as electronic switches between light transparency and light barrier for viewfinder assemblies according to the present invention.

The drawing schematically illustrates an exemplary embodiment of the object according to the present invention which is subsequently described in more detail on the basis of the figures.

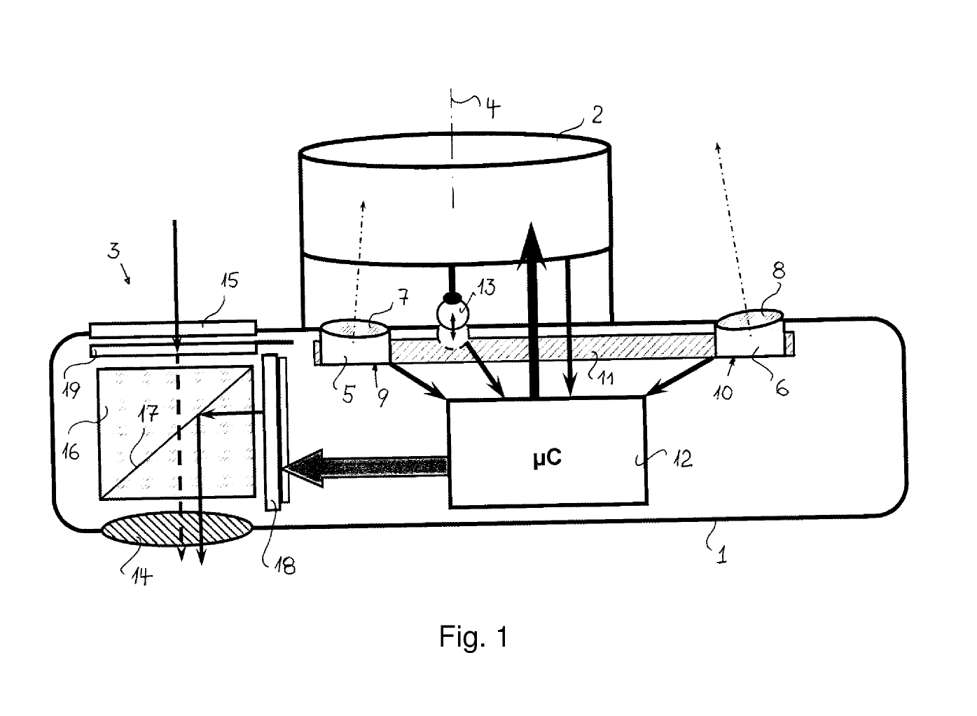

FIG. 1 shows a camera having a rangefinder and a combination viewfinder; and

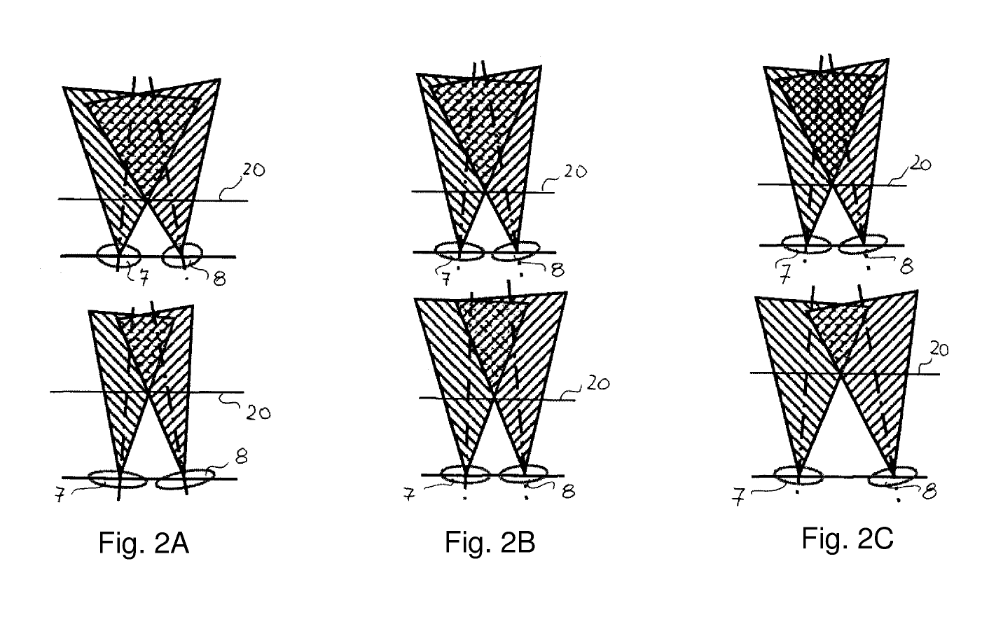

FIGS. 2A-2C show the influence of the optical and geometric parameters on the optoelectronic rangefinder.

The camera shown in FIG. 1 includes a housing 1 having a receiving lens 2 and a viewfinder 3. Two electronic image recording modules 5, 6 spaced apart are inserted into the front panel of housing 1 and in the viewing direction of optical axis 4 of receiving lens 4. Image recording modules 5, 6 are each made up of one measuring lens 7, 8 and an image recording sensor 9, 10 situated downstream. Image recording modules 5, 6 are preferably situated on a common baseplate 11. They may, however, also be inserted separate from each other in a respective opening in the front panel of housing 1.

The electronic image signals recorded by image recording modules 5, 6 are fed into a microprocessing unit 12 situated in housing 1 to ascertain the phase distance of the respective image points assigned to one another (arrows). Microprocessor unit 12 includes a calibration table for the object distance assigned to a phase distance in a memory. The software for operating microprocessor unit 12 may be updated and/or extended via a not-shown interface at housing 1.

Receiving lens 2 attached at housing 1 may be a manually focusable lens or a motor-driven adjustable lens. In a manner known per se, the manually focusable lens is provided with a control cam alongside which runs a roller lever 13. Roller lever 13 is provided with a not-shown electronic sensor to determine its deflection. The deflection signals corresponding with the focal distance of receiving lens 2 are also fed into microprocessor unit 12 (arrow). Motor-driven focusable lenses include an electronic scale to indicate the respective focal distance. These signals are also fed to microprocessor unit 12 (arrow).

Viewfinder 3 integrated into housing 1 includes a viewfinder eyepiece 14 and a viewfinder window 15. Prism 16 having a splitter surface 17 is situated in between [said viewfinder eyepiece and viewfinder window]. A display unit 18 may be observed via splitter surface 17. A switchable optoelectronic component 19 is situated in front of viewfinder window 15. Preferably, this is a PN-LCD (or PD-LC element) for the lightproof coverage of viewfinder window 15. Of course, a mechanical barrier known per se may also be provided at this point.

Display unit 18 displays image and/or data information (thick arrow) for visual observation generated by microprocessor unit 12 and/or an image recording chip. By covering the incidence of ambient light via viewfinder window 15, the visual observability of the display on display unit 18 may be improved.

In particular, microprocessor unit 12 determines the various informational facts about the distances and their difference derived from image recording modules 5, 6 and the sensor at receiving lens 2. These may, in addition to a display on display unit 18 or a not-shown display at the back panel of housing 1, be used for an autofocus setting of receiving lens 2 (arrow). Additionally, the specifications of respective receiving lenses 2 may be fed into microprocessor unit 12, the matching image bounding boxes be generated and shown on display unit 12.

FIG. 2 shows the influences of the image angles of measuring lenses 7, 8, the tilting angle of their optical axes and their distance from each other.

FIG. 2a) shows measuring lenses 7, 8 having short focal lengths and, for this reason, a wide image angle in comparison to measuring lenses 7, 8 having long focal lengths and, therefore, a more narrow image angle. The measuring area for the distance measurement is indicated by the overlapping cross-hatching of the image angles. A larger measuring area having better focal detail in the image sensor results from a larger overlapping area. A more narrow overlapping area results in a better resolution of the focal detail in focus and, therefore, in a more specific measurement.

FIG. 2b) shows the influence of the tilting angle of measuring lenses 7, 8 to each other. The more the optical axes of the measuring lens are tilted towards each other, the greater the measuring area and the better and more precise the centric detection of the focusing area. In addition, the tilting angle of both axes is to be as equal as possible to ensure a more precise overlapping of the distances of both axes to the target point. Potentially necessary differences owing to an asymmetrical arrangement of image recording modules 5, 6 relative to the optical axis of receiving lens 2 may be compensated by software in the basic adjustment of the rangefinder.

FIG. 2c) shows the influence of the distance of the two measuring lenses 7, 8 to each other. The shorter the distance, the greater the measuring area and the closer to the camera starts the overlapping of the image angles. In contrast, a further distance delivers a greater measuring basis having a greater image shift between the images of image recording modules 5, 6 and, therefore, a more accurate evaluation possibility of the phase distance.

The appropriate selection of the influence parameters depends on the number and the type of receiving lenses 2 to be taken into account and may be optimized through simple experiments by the skilled person. FIG. 2 provides the positional closeness by the starting point of overlapping area 20.

### LIST OF REFERENCE CHARACTERS

1 Housing
2 Receiving lens
3 Viewfinder
4 Optical axis of receiving lens
5,6 Image recording modules
7,8 Measuring lenses
9,10 Image recording sensors
11 Baseplate
12 Microprocessor unit
13 Roller lever
14 Viewfinder eyepiece
15 Viewfinder window
16 Prism
17 Splitter surface
18 Display unit
19 Switchable cover
20 Staring point of overlapping area

What is claimed is:

1. A camera having an optoelectronic rangefinder, a focusable receiving lens and a visually observable display unit for displaying data and/or images, wherein two electronic image recording modules, which are spaced apart and the optical axes of which are aligned with a common target point, are inserted as a rangefinder into the front panel of the housing of the camera and, in order to determine the phase distance of the images of the object space recorded by the image recording modules and to compare the determined phase distance to the values for the distances assigned for the different phase distances, which are stored in a calibration table, a microprocessor unit is provided in the housing and is connected with the signal outputs of the image recording modules.

2. The camera according to claim 1, wherein a sensor displaying the current focal distance of the receiving lens is assigned to the lens, and the sensor is connected to the microprocessor module for inputting the focal distance.

3. The camera according to claim 2, wherein the microprocessor unit is connected to the visually observable display unit to display the distance derived from the phase distance and the distance determined by the sensor.

4. The camera according to claim 3, wherein the display unit can display the difference between the distance derived from the phase distance and determined by the sensor of the focusing unit of the receiving lens, which is determined by the microprocessor unit, relative to the distance derived from the phase distance.

5. The camera according to claim 4, wherein the receiving lens is connected to a manual or motor-operable actuator for zeroing the difference of the distances displayed on the display unit.

6. The camera according to claim 1, wherein an optical viewfinder having a viewfinder eyepiece and a viewfinder window, an electronic viewfinder, an optoelectronic combination viewfinder and/or a back panel display for visually observing the object space are provided.

7. The camera according to claim 6, wherein the viewfinder window is dimmable.

8. The camera according to claim 7, wherein a switchable optoelectronic component for covering the viewfinder window is provided.

9. The camera according to claim 8, wherein a PNLC display is provided as optoelectronic component for covering the viewfinder window.
